(19) United States
(12) Patent Application Publication
(10) Pub. No.: US 2013/0234997 A1
(43) Pub. Date: Sep. 12, 2013

(54) INPUT PROCESSING APPARATUS, INPUT PROCESSING PROGRAM, AND INPUT PROCESSING METHOD

(71) Applicant: SONY CORPORATION, Tokyo (JP)

(72) Inventor: Nobuyoshi Miyokawa, Chiba (JP)

(73) Assignee: SONY CORPORATION, Tokyo (JP)

(21) Appl. No.: 13/781,887

(22) Filed: Mar. 1, 2013

(30) Foreign Application Priority Data
Mar. 8, 2012 (JP) 2012-051336

(51) Int. Cl. G06F 3/041

(52) U.S. Cl. CPC G06F 3/0418
USPC 345/178

(57) ABSTRACT

An input processing apparatus includes a touch detector, a touch transition acquisition unit, and an input processor. The touch detector is configured to be capable of detecting multiple touches. The touch transition acquisition unit is configured to acquire from the touch detector a touch transition being a transition of a touch position coordinate from a touch start point. The input processor is configured to determine, based on a touch detection result by the touch detector, whether or not to recognize the touch transition as a touch gesture.

### BACKGROUND

The present disclosure relates to an input processing apparatus, an input processing program, and an input processing method that enable a touch input to be performed.

In recent years, a remote user interface (RUI) is in widespread use. In the RUI, a user interface (UI) of one apparatus (operation target apparatus) is displayed on a screen of a different apparatus (remote apparatus) so that the user can operate the operation target apparatus through the screen of the remote apparatus.

In the RUI, the UI of the operation target apparatus (TV, etc.) may be adapted for operations by a remote controller while the remote apparatus (smart phone, etc.) may need operations by a touch panel. In such a case, in order to emulate operations for the operation target apparatus in the remote apparatus, a method of displaying virtual keys on the screen of the remote apparatus is assumed.

For example, Japanese Patent Application Laid-open No. HEI 05-145973 (hereinafter, referred to as Patent Document 1) discloses a “programmable remote control apparatus” having a configuration in which virtual keys are displayed on a screen and touch inputs with respect to such an area are handled as key inputs. Further, Japanese Unexamined Patent Application Publication No. 2010-517197 (hereinafter, referred to as Patent Document 2) discloses “gesturing with a multipoint sensing device” having a configuration in which inputs by key operations are emulated by touch gesture inputs (inputs corresponding to touch trajectories) into a touch panel.

### SUMMARY

However, as described in Patent Document 1, in the apparatus displaying the virtual keys on the screen, the screen of the apparatus is covered with the virtual keys. Therefore, it is difficult to use the screen for other purposes when the screen is used as the remote controller. Meanwhile, as described in Patent Document 2, in the apparatus using the gesture inputs, the user must memorize correspondences between the gesture inputs and the key inputs and there is a fear that operation errors of the gesture inputs may occur. Further, it is difficult to cancel a gesture input once the input is started, and hence an improvement in convenience is desirable.

In view of the above-mentioned circumstances, there is a need for providing an input processing apparatus, an input processing program, and an input processing method that enable a touch gesture input excellent in convenience to be performed.

According to an embodiment of the present disclosure, there is provided an input processing apparatus including a touch detector, a touch transition acquisition unit, and an input processor.

The touch detector is configured to be capable of detecting multiple touches.

The touch transition acquisition unit is configured to acquire from the touch detector a touch transition being a transition of a touch position coordinate from a touch start point.

The input processor is configured to determine, based on a touch detection result by the touch detector, whether or not to recognize the touch transition as a touch gesture.

With this configuration, the user can switch between a touch gesture input and a non-touch gesture input (screen scrolling, etc.) by changing a touch method and it is unnecessary to make the input processing apparatus dedicated to the touch gesture input. Therefore, the convenience can be enhanced.

The input processor may be configured to determine, based on the number of touches forming the touch transition, whether or not to recognize the touch transition as a touch gesture.

With this configuration, the user can decide whether or not to perform a touch gesture input by changing the number (inclusive change of number) of operators (fingers or styluses) forming the touch transition.

The input processor may be configured to recognize, when all of the plurality of touches forming the touch transition are moved away from the touch detector at the same time, the touch transition as a touch gesture, and not to recognize, when part of the plurality of touches forming the touch transition is moved away from the touch detector, the touch transition as a touch gesture.

With this configuration, the user can change a touch transition into a non-touch gesture input, i.e., cancel the touch gesture by moving part of the operators away from the touch detector after the touch transition is formed. Further, the user can perform a touch gesture input by moving all of the operators at the same time (inclusive cases where slight time lag exists) away from the touch detector after the touch transition is formed.

The input processor may be configured to recognize, when the number of a plurality of touches forming the touch transition is equal to or larger than a predetermined number, the touch transition as a touch gesture, and not to recognize, when the number of a plurality of touches forming the touch transition is smaller than the predetermined number, the touch transition as a touch gesture.

With this configuration, the user can perform a touch gesture input by forming a touch transition in the touch detector with a predetermined number or more of operators and to prevent a touch gesture input by forming a touch transition in the touch detector with operators fewer than the predetermined number.

The input processor may be configured to determine, based on presence or absence of a touch with respect to a determination area defined within a touch detection area, whether or not to recognize the touch transition as a touch gesture.

With this configuration, the user can decide whether or not to perform a touch gesture input by touching or not touching the determination area.

The input processor may be configured to, when a touch forming the touch transition is moved away from the touch detector, recognize the touch transition as a touch gesture in case where a touch is detected in the determination area and not to recognize the touch transition as a touch gesture in case where the touch is not detected in the determination area.

With this configuration, the user can change a touch transition into a non-touch gesture input, i.e., cancel the touch gesture by releasing the touch with respect to the determination area before the touch forming the touch transition is released.

The input processor may be configured to recognize the touch transition as a touch gesture when the touch is detected in the determination area and not to recognize the touch transition as a touch gesture when the touch is not detected in the determination area.

With this configuration, the user can perform a touch gesture input by touching the determination area while the touch transition is formed. Further, the user can prevent a touch gesture input by not touching the determination area while the touch transition is formed.

According to another embodiment of the present disclosure, there is provided an input processing program including a touch transition acquisition unit and an input processor.

The touch transition acquisition unit is configured to acquire, from a touch detector configured to be capable of detecting multiple touches, a touch transition being a transition of a touch position coordinate from a touch start point.

The input processor is configured to determine, based on a touch detection result by the touch detector, whether or not to recognize the touch transition as a touch gesture.

According to still another embodiment of the present disclosure, there is provided an input processing method including acquiring, by a touch transition acquisition unit, from a touch detector configured to be capable of detecting multiple touches, a touch transition being a transition of a touch position coordinate from a touch start point.

An input processor determines, based on a touch detection result by the touch detector, whether or not to recognize the touch transition as a touch gesture.

As described above, according to the embodiments of the present disclosure, it is possible to provide an input processing apparatus, an input processing program, and an input processing method that enable a touch gesture input excellent in convenience to be performed. These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a perspective view showing an outer appearance of an input processing apparatus according to a first embodiment of the present disclosure;

FIG. 2 is a schematic view showing a hardware configuration of the input processing apparatus;

FIG. 3 is a schematic view showing a functional configuration of the input processing apparatus;

FIG. 4 is a schematic view showing a display image of the input processing apparatus;

FIG. 5 is a schematic view showing an operation of the input processing apparatus;

FIG. 6 is a schematic view showing an operation of the input processing apparatus;

FIG. 7 is a schematic view showing an operation of the input processing apparatus;

FIG. 8 is a schematic view showing an operation of the input processing apparatus;

FIG. 9 is a flowchart showing an operation of the input processing apparatus;

FIG. 10 is a flowchart showing an operation of the input processing apparatus;

FIG. 11 is a schematic view showing a functional configuration of an input processing apparatus according to a second embodiment of the present disclosure;

FIG. 12 is a schematic view showing a display image of the input processing apparatus;

FIG. 13 is a schematic view showing an operation of the input processing apparatus;

FIG. 14 is a schematic view showing an operation of the input processing apparatus; and

FIG. 15 is a flowchart showing an operation of the input processing apparatus.

### DETAILED DESCRIPTION OF EMBODIMENTS

### First Embodiment

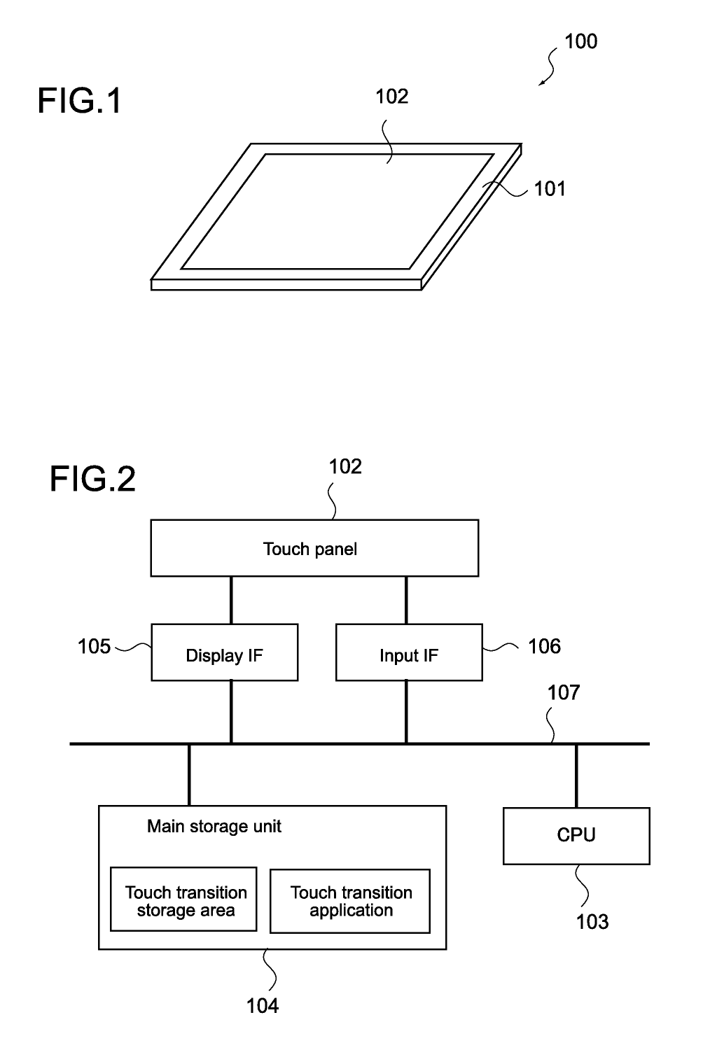

An input processing apparatus according to a first embodiment will be described. FIG. 1 is a schematic view showing an outer appearance of an input processing apparatus 100 according to this embodiment. FIG. 2 is a block diagram showing a hardware configuration of the input processing apparatus 100. The input processing apparatus 100 only needs to be capable of detecting a touch (physical contact of operator). For example, the input processing apparatus 100 may be a tablet type personal computer with a touch panel, an information processing apparatus such as a smart phone, or a remote controller for remotely controlling a different information processing apparatus.

As shown in FIG. 1, the input processing apparatus 100 includes a touch panel 102 provided to a casing 101. The touch panel 102 is capable of detecting a touch of an operator (user's finger or stylus) on a panel as well as displaying an image, and also capable of detecting multiple touches (simultaneous multipoint detection). The touch detection method of the touch panel 102 is not particularly limited. For example, a capacitance method may be used.

As shown in FIG. 2, the input processing apparatus 100 may include, in addition to the touch panel 102, a central processing unit (CPU) 103, a main storage unit 104, a display interface 105 (hereinafter, referred to as display IF), and an input interface 106 (hereinafter, referred to as input IF). Those are connected to each other via a bus 107. The display IF 105 and the input IF 106 are connected to the touch panel 102. The main storage unit 104 includes a touch transition storage area for storing a touch transition (described later) and stores a touch transition application that operates according to the touch transition.

The CPU 103 reads software (touch transition application, etc.) stored in the main storage unit 104, generates a display image to be displayed on the touch panel 102, and supplies the display image to the display IF 105. The display IF 105 controls the touch panel 102 to display the display image. The input IF 106 supplies a touch transition based on touch position coordinates detected in the touch panel 102, to the touch transition storage area of the main storage unit 104.

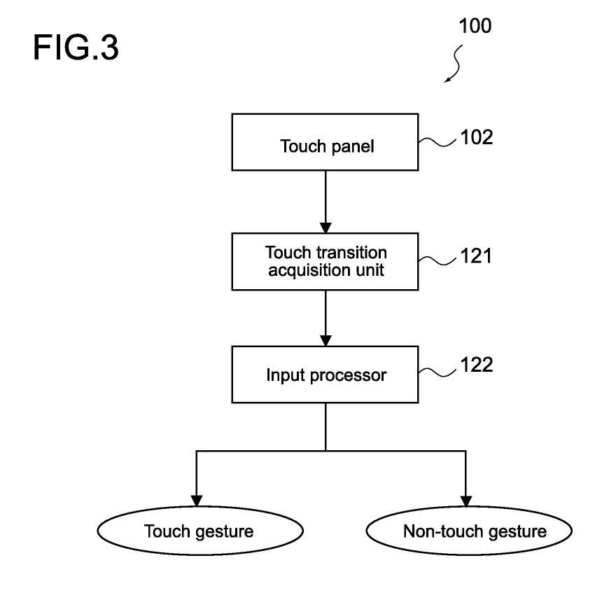

The input processing apparatus 100 realizes the following functional configuration in cooperation between such a hardware configuration and the software. FIG. 3 is a block diagram showing the functional configuration of the input processing apparatus 100. As shown in the figure, the input processing apparatus 100 includes a touch transition acquisition unit 121 and an input processor 122.

Based on touch position coordinates detected in the touch panel 102 and supplied via the input IF 106, the touch transition acquisition unit 121 acquires a “touch transition.” The touch transition means a transition from a touch start point, which is a position on the touch panel 102 at which the touch is newly detected, i.e., a moving path of the operator held in contact with the touch panel 102.

Specifically, the touch transition acquisition unit 121 acquires position coordinates of a touch position per a unit time (e.g., 0.1 seconds) detected in the touch panel 102. When the position coordinates are supplied in a state in which a period of time when the position coordinates are not supplied (touch is not detected) continues for a predetermined period of time, the touch transition acquisition unit 121 considers those position coordinates as the touch start point. When further position coordinates are continuously supplied, the touch transition acquisition unit 121 determines that the touch continues and considers a transition of the position coordinates from the start point as the touch transition.

Note that, as described above, the touch panel 102 employs the detection method in which the multipoint detection can be performed, and hence, in case where a plurality of operators (e.g., user's two fingers) are used, the touch transition acquisition unit 121 detects respective touch transitions of those operators. The touch transition acquisition unit 121 supplies the detected touch transitions to the input processor 122.

Based on a touch detection result by the touch panel 102, the input processor 122 determines whether or not to recognize the touch transition as a touch gesture. Here, the input processor 122 according to this embodiment uses the number of touches (inclusive change of number) forming the touch transition in order to determine whether or not to recognize the touch transition as a touch gesture.

Although will be described later in detail, the input processor 122 recognizes the touch transition as a touch gesture when the number of touches forming the touch transition is equal to or lager than a predetermined number. Meanwhile, the input processor 122 does not recognize the touch transition as a touch gesture when the number of touches forming the touch transition is smaller than the predetermined number.

Further, the input processor 122 recognizes the touch transition as a touch gesture when all of the plurality of touches forming the touch transition are moved away from the touch panel 102 at the same time. Note that, “at the same time” includes cases where a slight time lag exists. Meanwhile, the input processor 122 does not recognize the touch transition as a touch gesture when part of the plurality of touches forming the touch transition is moved away from the touch panel 102.

When the input processor 122 recognizes the touch transition as a touch gesture, the input processing apparatus 100 executes an operation assigned to that touch gesture. Otherwise, when the input processor 122 does not recognize the touch transition as a touch gesture, the input processing apparatus 100 activates various functions according to the touch transition application.

### Operation of Input Processing Apparatus

Hereinafter, an operation of the input processing apparatus 100 will be described. Note that, hereinafter, a description will be given assuming that the operator that operates the touch panel 102 is user's finger(s).

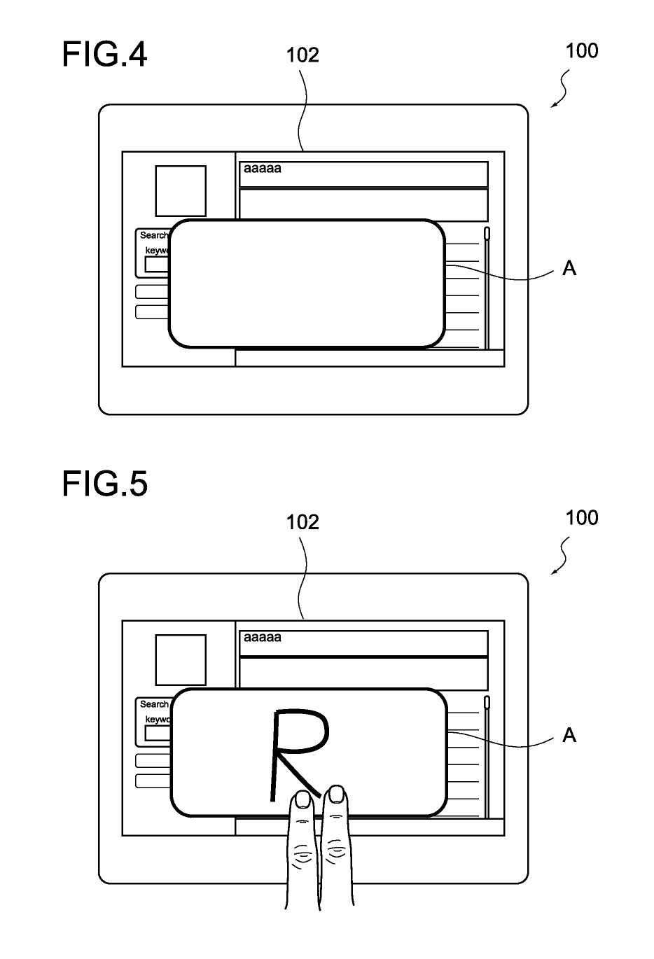

FIG. 4 is a schematic view showing a display screen of the touch panel 102. As shown in the figure, an arbitrary user interface is displayed on the display screen of the touch panel 102. A gesture recognition area A is also displayed on the display screen. The gesture recognition area A can receive an input based on a touch gesture. The gesture recognition area A may be clearly presented to the user or may be internally set.

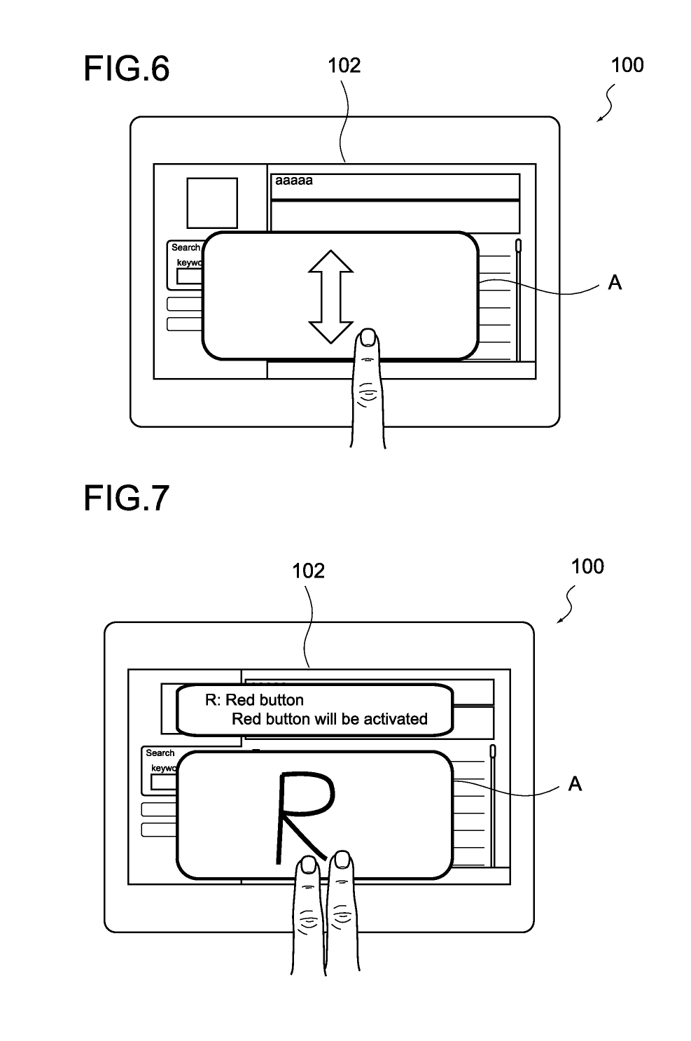

Before a detailed description of the operation is given, the outline of the operation will be described. FIGS. 5 and 6 are schematic views each showing the operation of the input processing apparatus 100.

As shown in FIG. 5, when the user touches the gesture recognition area A with a predetermined number or more of fingers (e.g., two fingers) and moves the fingers to draw a predetermined pattern (hereinafter, referred to as drag or drag operation), the input processing apparatus 100 recognizes it as a touch gesture. The input processing apparatus 100 handles that touch gesture as an operation input assigned to that touch gesture (e.g., key press).

Further, as shown in FIG. 6, when the user drags the touch panel 102 with a finger(s) fewer than the predetermined number (e.g., single finger), the input processing apparatus 100 recognizes it as a non-touch gesture. For example, the input processing apparatus 100 scrolls the display image of the touch panel 102 according to the drag operation. In addition to this, the input processing apparatus 100 activates various functions (hereinafter, referred to as application basic function) according to the touch transition application.

That is, by changing the number of fingers to perform a drag operation, the user can selectively use the touch gesture and the application basic function.

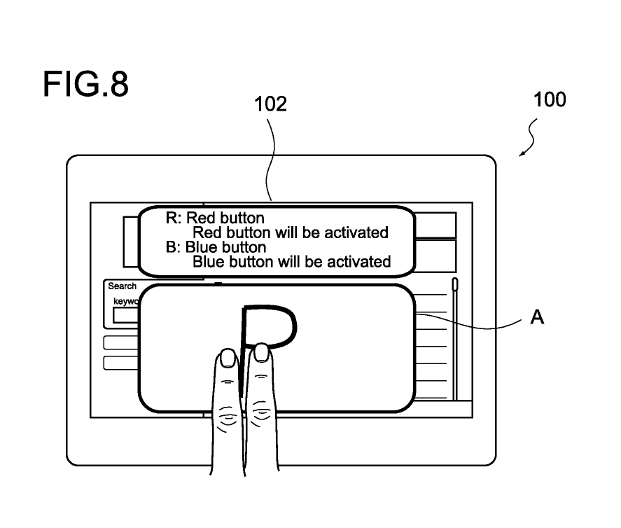

Note that, when a touch gesture as a key press is inputted, the input processing apparatus 100 is also capable of displaying on the touch panel 102 a message for assisting the user. FIGS. 7 and 8 are views each showing an exemplary message displayed on the touch panel 102.

When the input processing apparatus 100 detects that the predetermined number or more of fingers perform a drag operation and recognizes it as a touch gesture, the input processing apparatus 100 starts to analyze the touch gesture. The input processing apparatus 100 performs matching between the touch gesture and data in a touch gesture analysis program and recognizes a most likely matching letter or symbol. As shown in FIG. 7, the input processing apparatus 100 displays the recognized letter or symbol, a function activated by the recognized letter or symbol, and the like as an message.

When the input processing apparatus 100 does not recognize the touch gesture as being a particular letter or symbol in the middle of the touch gesture, the input processing apparatus 100 displays, as shown in FIG. 8, a letter or symbol that can be estimated based on the touch gesture before this point of time, a function activated by the letter or symbol, and the like as a message. When the touch gesture proceeds, the input processing apparatus 100 changes the message according to the progress of the search for letters or symbols.

Further, when the user drags the touch panel 102 with the predetermined number or more of fingers and moves all of the fingers away from the touch panel 102 at the same time (inclusive slight time lag) after the drag operation, the input processing apparatus 100 recognizes it as a touch gesture. Meanwhile, when the user leaves at least one finger and moves other fingers away from the touch panel 102 during or after the drag operation, the input processing apparatus 100 recognizes it as a non-touch gesture.

That is, the user can complete the touch gesture by moving all of the fingers at the same time away from the touch panel 102 after the drag operation, and can cancel the touch gesture by moving part of the fingers away from the touch panel 102 during or after the drag operation.

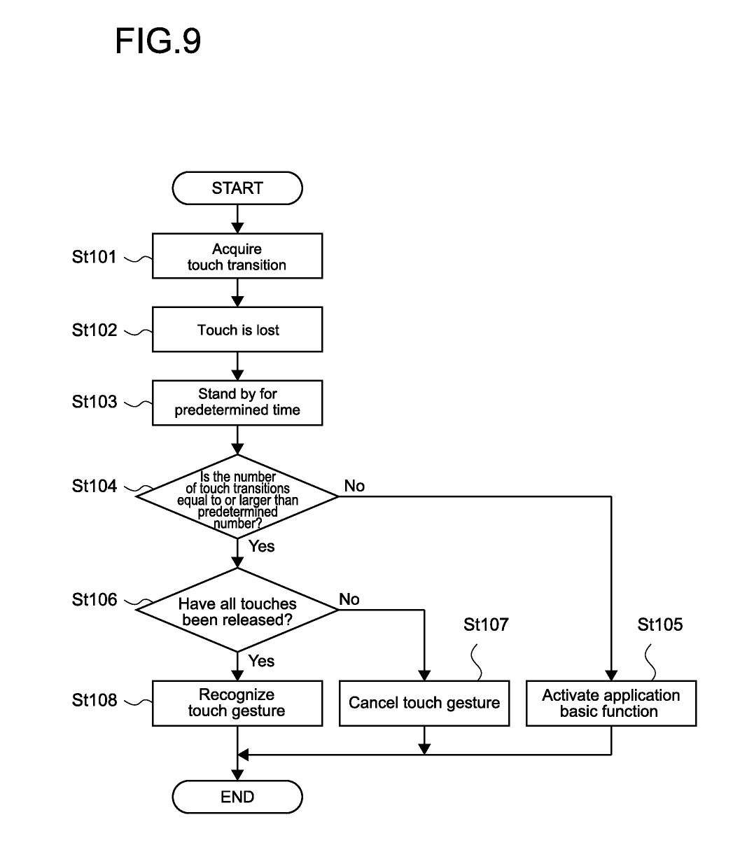

The detailed operation of the input processing apparatus 100 making the above-mentioned operation possible will be described. FIG. 9 is a flowchart showing the operation of the input processing apparatus 100.

First, the touch transition acquisition unit 121 acquires the touch transition (St101). As described above, the touch transition acquisition unit 121 acquires and retains a touch transition based on position coordinates of a touch per a unit time.

When one or more of the position coordinates of the touch are lost (St102), the input processor 122 stands by for a predetermined period of time (St103). That is because, when the user touching the touch panel 102 with the plurality of fingers tries to move all of the fingers away from the touch panel 102 at the same time, in a precise sense, a slight time lag occurs before the fingers are moved away from the touch panel 102.

After the input processor 122 stands by for the predetermined period of time, the input processor 122 checks whether or not a predetermined number or more of touch transitions are retained (St104). When the number of touch transitions are smaller than the predetermined number (St104: No), the input processor 122 recognizes the touch transition as a non-touch gesture and executes the application basic function (St105). With this, when the user drags the gesture recognition area A with the fingers fewer than the predetermined number, the application basic function is executed. For example, scrolling or the like of the display image is performed according to the drag operation.

When the number of touch transitions are equal to or larger than the predetermined number (St104: Yes), the input processor 122 checks whether or not one or more position coordinates of the touch exist (St106). When the one or more position coordinates of the touch exist (St106: No), the input processor 122 recognizes the touch transition as a non-touch gesture and thus cancels the touch gesture (St107).

When any position coordinates of the touch do not exist (St106: Yes), the input processor 122 recognizes the touch transition as a touch gesture (St108). With this, when the user releases all of the fingers touching the touch panel 102 at the same time, an input based on the touch gesture is enabled. Otherwise, when the user releases part of the fingers touching the touch panel 102 while leaving at least one finger, the input based on the touch gesture is canceled.

In accordance with the above-mentioned operations of the input processing apparatus 100, the user can switch between the touch gesture and the application basic function by changing the number of fingers to perform a drag operation, and to cancel an input of the touch gesture in the middle of the touch gesture.

### Operation of Input Processing Apparatus as Remote Controller

As described above, the user can switch between the touch gesture and the application basic function by using the input processing apparatus 100. That is highly convenient, in particular, in case where the input processing apparatus 100 operates as a remote controller of a different apparatus.

Specifically, the input processing apparatus 100 is capable of handling the touch gesture as a key press of the different input processing apparatus when the input processing apparatus 100 recognizes the touch transition as a touch gesture, and capable of using the touch transition for operating the input processing apparatus 100 when the input processing apparatus 100 does not recognize the touch transition as a touch gesture.

With this, the input processing apparatus 100 does not need to display on the touch panel 102 virtual keys for the different input processing apparatus. Therefore, the display image of the touch panel 102 can be prevented from being covered with the virtual keys. That is, the user can operate the input processing apparatus 100 in parallel to the operation of the different input processing apparatus even when the user uses the input processing apparatus 100 as the remote controller of the different information processing apparatus.

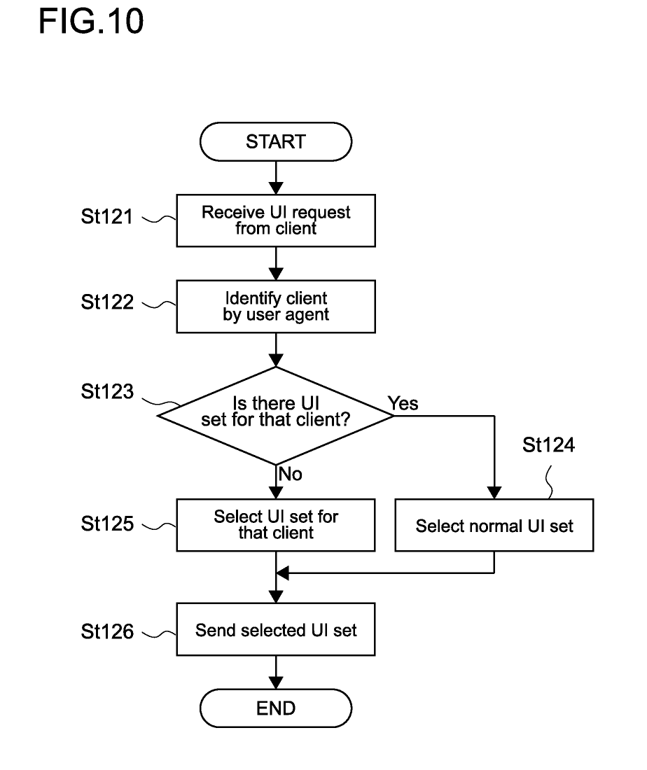

FIG. 10 is a flowchart when the input processing apparatus 100 operates as the remote controller of the different input processing apparatus (not shown). When the input processing apparatus 100 receives a user interface (UI) request from a client (different input processing apparatus) (St121), the input processing apparatus 100 identifies the client by a user agent (St122).

If the input processing apparatus 100 includes a UI set of the client (St123: Yes), the input processing apparatus 100 selects a normal UI set (St124). If the input processing apparatus 100 does not include the UI set of the client (St123: No), the input processing apparatus 100 selects a UI set for the client (St125). The input processing apparatus 100 sends the selected UI set to the client (St126).

In this manner, the input processing apparatus 100 is capable of serving as the remote controller of the different input processing apparatus.

As described above, in the input processing apparatus 100 according to this embodiment, whether or not to recognize the touch transition as a touch gesture is determined based on the number of touches forming the touch transition. With this, by changing the number of fingers to perform a drag operation, the user can change a function to be activated by a drag operation and cancel the touch gesture.

### Second Embodiment

An input control apparatus according to the second embodiment will be described. Note that, in this embodiment, the same components as those of the first embodiment will be denoted by the same reference symbols and a description thereof will be omitted.

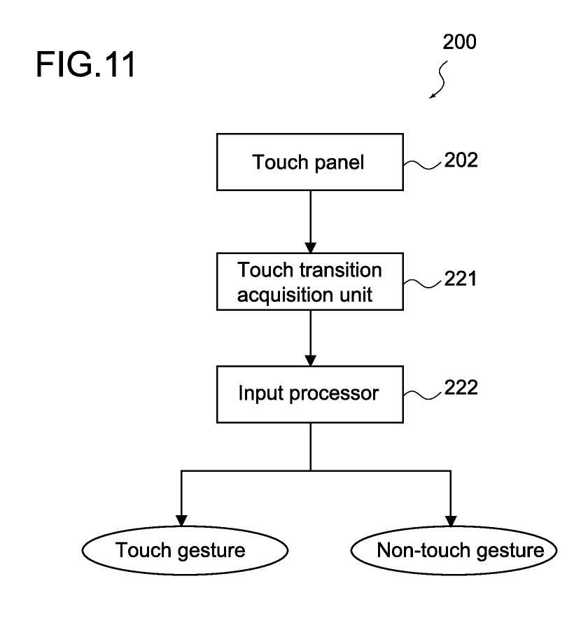

FIG. 11 is a block diagram showing a functional configuration of an input processing apparatus 200. As shown in the figure, the input processing apparatus 200 includes a touch panel 202, a touch transition acquisition unit 221, and an input processor 222.

The touch transition acquisition unit 221 acquires a “touch transition” based on touch information detected in the touch panel 202 as in the first embodiment.

Note that, as described above, the touch panel 202 employs the detection method in which the multipoint detection can be performed, and hence, in case where a plurality of operators (e.g., user's two fingers) are used, the touch transition acquisition unit 221 detects respective touch transitions of those operators. The touch transition acquisition unit 221 supplies the detected touch transitions to the input processor 222.

Based on a touch detection result by the touch panel 202, the input processor 222 determines whether or not to recognize the touch transition as a touch gesture. Here, the input processor 222 according to this embodiment uses presence and absence of the touch with respect to the determination area in order to determine whether or not to recognize the touch transition as a touch gesture. The determination area is an area defined in a touch detection area being an area of the touch panel 202 in which a touch can be detected.

Although will be described later in detail, the input processor 222 recognizes the touch transition as a touch gesture when the touch is detected in the determination area. Meanwhile, the input processor 222 does not recognize the touch transition as a touch gesture when the touch is not detected in the determination area.

Further, when the touch forming the touch transition is moved away from the touch panel 202, the input processor 222 recognizes the touch gesture as a touch transition in case where the touch is detected in the determination area and does not recognize the touch gesture as a touch transition in case where the touch is not detected in the determination area.

When the input processor 222 recognizes the touch transition as a touch gesture, the input processing apparatus 200 executes an operation assigned to the touch gesture. Otherwise, when the input processor 222 does not recognize the touch transition as a touch gesture, the input processing apparatus 200 activates various functions according to a running application.

### Operation of Input Processing Apparatus

Hereinafter, an operation of the input processing apparatus 200 will be described. Note that, hereinafter, a description will be given assuming that the operator of the touch panel 202 is user's finger(s).

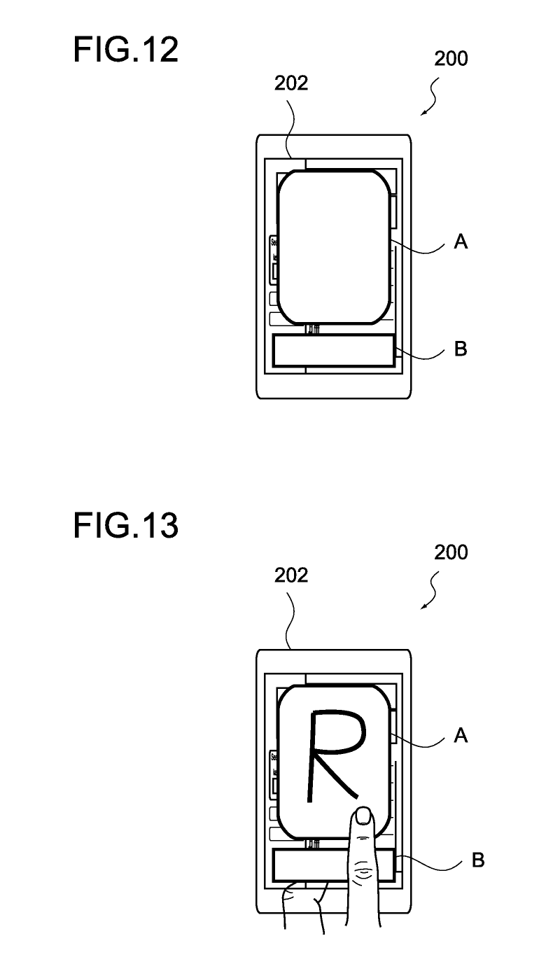

FIG. 12 is a schematic view showing a display screen of the touch panel 202. As shown in the figure, on the display screen of the touch panel 202, an arbitrary user interface is displayed. On the display screen, a gesture recognition area A and a determination area B are also displayed. The gesture recognition area A can receive an input based on a touch gesture. The gesture recognition area A may be clearly presented to the user or may be internally set. The determination area B is an area to be used for recognizing the touch gesture and is clearly presented to the user.

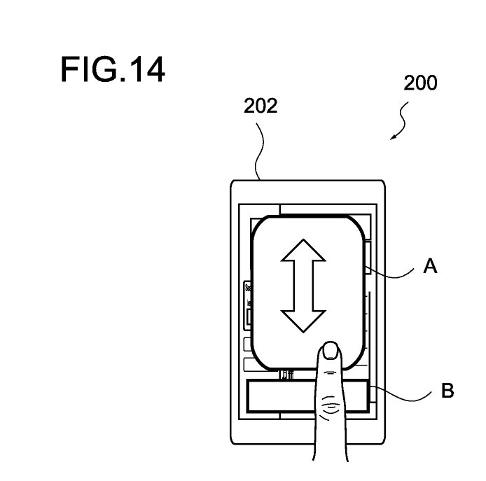

Before a detailed description, the outline of the operation will be described. FIGS. 13 and 14 are schematic views each showing the operation of the input processing apparatus 100.

As shown in FIG. 13, in a state in which the user touches the determination area B with a finger, when the user performs a drag operation in the gesture recognition area A, the input processing apparatus 200 recognizes it as a touch gesture. The input processing apparatus 200 handles that touch gesture as an operation input assigned to that touch gesture (e.g., key press).

Further, as shown in FIG. 14, when the user performs a drag operation in the gesture recognition area A in a state in which the user does not touch the determination area B with the finger, the input processing apparatus 200 recognizes it as a non-touch gesture. For example, the input processing apparatus 200 scrolls the display image of the touch panel 202 according to the drag operation. In addition to this, the input processing apparatus 200 activates various functions (hereinafter, referred to as application basic function) according to a running application.

That is, by touching or not touching the determination area B, the user can selectively use the touch gesture and the application basic function.

Further, when the user touches the determination area B and moves the finger away from the determination area B after the drag operation, the input processing apparatus 200 recognizes it as a touch gesture. Meanwhile, when the user moves the finger away from the determination area B after the drag operation before the user moves the finger away from the gesture recognition area A, the input processing apparatus 200 recognizes it as a non-touch gesture.

That is, the user can complete the touch gesture by first releasing the finger touching the gesture recognition area A after the drag operation. Otherwise, the user can cancel the touch gesture by first releasing the finger touching the determination area B after the drag operation.

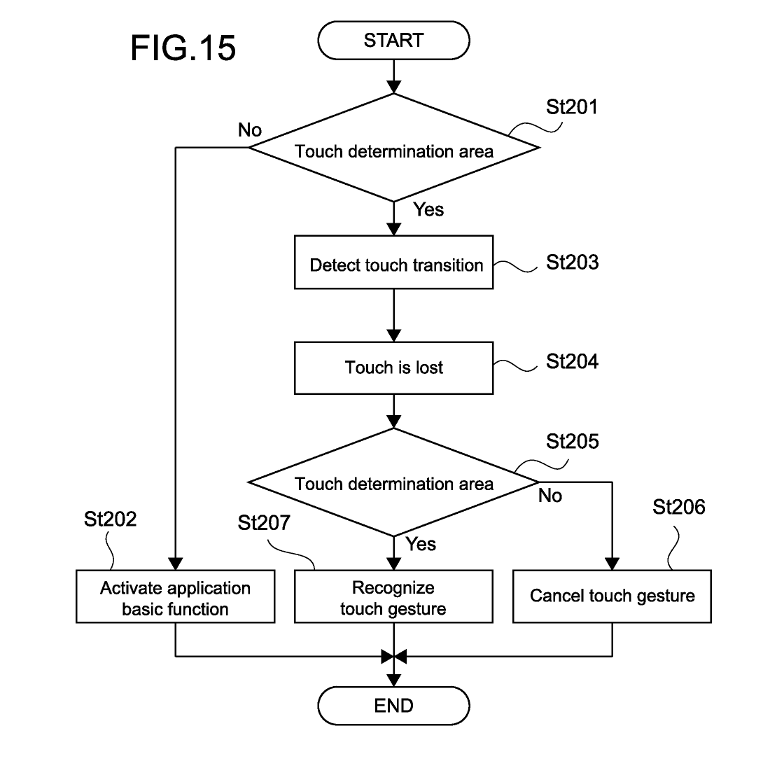

A detailed operation of the input processing apparatus 200 making the above-mentioned operation possible will be described. FIG. 15 is a flowchart showing the operation of the input processing apparatus 200.

First, the input processor 222 determines whether or not a touch is detected in the determination area B (St201). When the touch is not detected in the determination area B (St201: No), the input processor 222 recognizes the touch transition as a non-touch gesture and executes the application basic function (St202). With this, when the user performs a drag operation in the gesture recognition area A and does not touch any point in the determination area B, the application basic function is executed. For example, scrolling and the like of the display image are performed according to the drag operation.

When the touch is detected in the determination area B (St201: Yes), a touch transition detector 201 acquires a touch transition (St203). As described above, the touch transition acquisition unit 221 acquires and retains the touch transition based on position coordinates of the touch per a unit time. A plurality of touch transitions are present in case where the user touches the gesture recognition area A with a plurality of fingers.

When one or more of the position coordinates of the touch are lost (St204), the input processor 222 checks whether or not the touch is detected in the determination area B (St205). When the touch is not detected in the determination area B (St205: No), the input processor 122 recognizes the touch transition as a non-touch gesture, i.e., cancels the touch gesture (St206).

When the touch is detected in the determination area B (St025: Yes), the input processor 222 recognizes the touch transition as a touch gesture (St207). With this, when the user moves the finger away from the gesture recognition area A after the drag operation, an input based on the touch gesture is enabled if the user touches the determination area B. Otherwise, if the user does not touch the determination area B, the input based on the touch gesture is cancelled.

In accordance with the above-mentioned operations of the input processing apparatus 200, by touching or not touching the determination area, the user can switch between the touch gesture and the application basic function and cancel an input of the touch gesture in the middle of the touch gesture.

The present disclosure is not limited only to the above-mentioned embodiments. Modifications can be made without departing from the gist of the present disclosure.

Although, in the above-mentioned embodiments, touches are detected by the touch panel, the present disclosure is not limited thereto. Instead of the touch panel, touches may be detected by a touch pad without an image display function.

It should be noted that the present disclosure may also take the following configurations.

(1) An input processing apparatus, including:

a touch detector configured to be capable of detecting multiple touches;

a touch transition acquisition unit configured to acquire from the touch detector a touch transition being a transition of a touch position coordinate from a touch start point; and

an input processor configured to determine, based on a touch detection result by the touch detector, whether or not to recognize the touch transition as a touch gesture.

(2) The input processing apparatus according to Item (1), in which

the input processor is configured to determine, based on the number of touches forming the touch transition, whether or not to recognize the touch transition as a touch gesture.

(3) The input processing apparatus according to Item (1) or (2), in which

the input processor is configured to recognize, when all of the plurality of touches forming the touch transition are moved away from the touch detector at the same time, the touch transition as a touch gesture, and not to recognize, when part of the plurality of touches forming the touch transition is moved away from the touch detector, the touch transition as a touch gesture.

(4) The input processing apparatus according to any one of Items (1) to (3), in which

the input processor is configured to recognize, when the number of a plurality of touches forming the touch transition is equal to or larger than a predetermined number, the touch transition as a touch gesture, and not to recognize, when the number of a plurality of touches forming the touch transition is smaller than the predetermined number, the touch transition as a touch gesture.

(5) The input processing apparatus according to any one of Items (1) to (4), in which

the input processor is configured to determine, based on presence or absence of a touch with respect to a determination area defined within a touch detection area, whether or not to recognize the touch transition as a touch gesture.

(6) The input processing apparatus according to any one of Items (1) to (5), in which

the input processor is configured to, when a touch forming the touch transition is moved away from the touch detector, recognize the touch transition as a touch gesture in case where the touch is detected in the determination area and not to recognize the touch transition as a touch gesture in case where the touch is not detected in the determination area.

(7) The input processing apparatus according to any one of Items (1) to (6), in which

the input processor is configured to recognize the touch transition as a touch gesture when the touch is detected in the determination area and not to recognize the touch transition as a touch gesture when the touch is not detected in the determination area.

(8) An input processing program that causes a computer to function as:

a touch transition acquisition unit configured to acquire, from a touch detector configured to be capable of detecting multiple touches, a touch transition being a transition of a touch position coordinate from a touch start point; and

an input processor configured to determine, based on a touch detection result by the touch detector, whether or not to recognize the touch transition as a touch gesture.

(9) An input processing method, including:

acquiring, by a touch transition acquisition unit, from a touch detector configured to be capable of detecting multiple touches, a touch transition being a transition of a touch position coordinate from a touch start point; and

determining, by an input processor, based on a touch detection result by the touch detector, whether or not to recognize the touch transition as a touch gesture.

The present disclosure contains subject matter related to that disclosed in Japanese Priority Patent Application JP 2012-051336 filed in the Japan Patent Office on Mar. 8, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An input processing apparatus, comprising:
a touch detector configured to be capable of detecting multiple touches;
a touch transition acquisition unit configured to acquire from the touch detector a touch transition being a transition of a touch position coordinate from a touch start point; and
an input processor configured to determine, based on a touch detection result by the touch detector, whether or not to recognize the touch transition as a touch gesture.

2. The input processing apparatus according to claim 1, wherein
the input processor is configured to determine, based on the number of touches forming the touch transition, whether or not to recognize the touch transition as a touch gesture.

3. The input processing apparatus according to claim 2, wherein
the input processor is configured to recognize, when all of the plurality of touches forming the touch transition are moved away from the touch detector at the same time, the touch transition as a touch gesture, and not to recognize, when part of the plurality of touches forming the touch transition is moved away from the touch detector, the touch transition as a touch gesture.

4. The input processing apparatus according to claim 2, wherein
the input processor is configured to recognize, when the number of a plurality of touches forming the touch transition is equal to or larger than a predetermined number, the touch transition as a touch gesture, and not to recognize, when the number of a plurality of touches forming the touch transition is smaller than the predetermined number, the touch transition as a touch gesture.

5. The input processing apparatus according to claim 1, wherein
the input processor is configured to determine, based on presence or absence of a touch with respect to a determination area defined within a touch detection area, whether or not to recognize the touch transition as a touch gesture.

6. The input processing apparatus according to claim 5, wherein
the input processor is configured to, when a touch forming the touch transition is moved away from the touch detector, recognize the touch transition as a touch gesture in case where the touch is detected in the determination area and not to recognize the touch transition as a touch gesture in case where the touch is not detected in the determination area.

7. The input processing apparatus according to claim 5, wherein
the input processor is configured to recognize the touch transition as a touch gesture when the touch is detected in the determination area and not to recognize the touch transition as a touch gesture when the touch is not detected in the determination area.

8. An input processing program that causes a computer to function as:
a touch transition acquisition unit configured to acquire, from a touch detector configured to be capable of detecting multiple touches, a touch transition being a transition of a touch position coordinate from a touch start point; and
an input processor configured to determine, based on a touch detection result by the touch detector, whether or not to recognize the touch transition as a touch gesture.

9. An input processing method, comprising:
acquiring, by a touch transition acquisition unit, from a touch detector configured to be capable of detecting multiple touches, a touch transition being a transition of a touch position coordinate from a touch start point; and
determining, by an input processor, based on a touch detection result by the touch detector, whether or not to recognize the touch transition as a touch gesture.
